(19) United States
(12) Patent Application Publication
(10) Pub. No.: US 2026/0213060 A1
(43) Pub. Date: Jul. 23, 2026

(54) A PLANAR WINDING ASSEMBLY FOR POWER APPLICATIONS AND A METHOD OF MANUFACTURING SUCH ASSEMBLY

(71) Applicant: AALBORG UNIVERSITET, Aalborg Øst (DK)

(72) Inventors: Hongbo ZHAO, Aalborg SØ (DK); Zhixing YAN, Aalborg Øst (DK); Shaokang LUAN, Aalborg Øst (DK); Thore Stig AUNSBORG, Aalborg Øst (DK); Stig MUNK-NIELSEN, Asaa (DK)

(21) Appl. No.: 19/133,982

(22) PCT Filed: Dec. 5, 2023
(86) PCT No.: PCT/EP2023/084293

§ 371 Date: May 29, 2025

(30) Foreign Application Priority Data
Dec. 5, 2022 (DK) PA202270581

(51) Int. Cl. H01F 27/28; H01F 27/24; H01F 27/32; H01F 41/04

(52) U.S. Cl. CPC H01F 27/2804; H01F 27/24; H01F 27/323; H01F 41/041; H01F 2027/2809

(57) ABSTRACT

The present invention concerns a planar winding assembly for power applications, said assembly comprising a frame accommodating a stack of a plurality of printed circuit boards (PCBs), each comprising at least one conductive winding on the PCB, wherein the stack comprises an uppermost first PCB comprising an electrically insulating layer having a top surface and a bottom surface, where the bottom surface is provided with a conductive winding having a first winding pattern; at least one second PCB comprising an electrically insulating layer having a top surface and a bottom surface with conductive windings thereon, where the top surface is provided with the first winding pattern and the bottom surface is provided with a second winding pattern corresponding to the first winding pattern; a lowermost first PCB, which is similar to the uppermost first PCB but positioned with the winding facing upwards; means for holding the plurality of PCBs tightly against each other in the stacked configuration, and the frame encompasses the stack of PCBs. The invention further concerns a method of manufacturing a planar winding assembly for high-power applications.

### FIELD OF THE INVENTION

The present invention relates to a planar winding assembly for power applications, such as a planar transformer or a planar inductor. The invention further relates to a method of manufacturing such planar winding assembly.

### BACKGROUND OF THE INVENTION

Planar winding assemblies for high-power applications are used for power supplies and other applications. Planar transformers and inductors are high frequency components used in isolated switch-mode power supplies operating at high frequency. Planar transformers usually contain winding turns made of thin copper sheets riveted together at the ends of turns in the case of high current windings, or windings etched on a PCB in a spiral form. In the development of such magnetic transformer and inductor modules efforts are being made to reduce the size. Accordingly, planar magnetic components, such as transformers and inductors, have been provided with low profiles fabricated with circuits and multiple layer printed circuit boards (PCB). Examples of such planar transformers are known from e.g. U.S. Pat. No. 5,781,093 and U.S. Pat. No. 5,010,314.

The drawbacks with the planar transformers, such as high-power magnetics are that such high-power magnetics are difficult and costly to manufacture and are large in size. The conventional planar magnetics are preferably connected to different PCBs in parallel. Conventional planar magnetics can be connected in series using a series of extra connector pins and through-holes. This is difficult and costly to produce when the number of PCB layers is large. Another limitation in conventional planar magnetics is that there is a high thermal stress which limits the maximum power which the planar magnetic can be subjected to.

Thus, to improve the performance of the planar magnetics it is found that power components need to dissipate more heat in a more narrow area. Accordingly, it is an object of the present invention to provide a modular power magnetics for high-power applications that reduces the undesired effects of the conventional planar magnetics known in the art.

### SUMMARY OF THE INVENTION

This object is achieved in a first aspect of the invention by providing a planar winding assembly for power applications, said assembly comprising a frame accommodating a stack of a plurality of printed circuit boards (PCBs), each comprising at least one conductive winding on the PCB, wherein the stack comprises an uppermost first PCB comprising an electrically insulating layer having a top surface and a bottom surface, where the bottom surface is provided with a conductive winding having a first winding pattern; at least one second PCB comprising an electrically insulating layer having a top surface and a bottom surface with conductive windings thereon, where the top surface is provided with the first winding pattern and the bottom surface is provided with a second winding pattern mirroring the first winding pattern; a lowermost first PCB, which is the same or at least similar to the uppermost first PCB but positioned with the winding facing upwards, and means for holding the plurality of PCBs tightly against each other in the stacked configuration, and the frame encompasses the stack of PCBs.

In a variant of this first aspect, there is provided a planar winding assembly for power applications, said assembly comprising a frame accommodating a stack of a plurality number (N) of printed circuit boards (PCBs), each comprising at least one conductive winding on the PCB, wherein the stack comprises an uppermost first PCB comprising an electrically insulating layer having a top surface and a bottom surface, where the bottom surface is provided with a conductive winding having a first winding pattern; a PCB-2 comprising an electrically insulating layer having a top surface and a bottom surface with conductive windings thereon, where the top surface is provided with the first winding pattern and the bottom surface is provided with a second winding pattern; a PCB-3 comprising an electrically insulating layer having a top surface and a bottom surface with conductive windings thereon, where the top surface is provided with the second winding pattern and the bottom surface is provided with a third winding pattern; a PCB-(n-1) comprising an electrically insulating layer having a top surface and a bottom surface with conductive windings thereon, where the top surface is provided with the winding pattern corresponding to the bottom winding on the PCB-(n-2) and the bottom surface is provided with a (n-1) winding pattern; a PCB-n comprising an electrically insulating layer having a top surface and a bottom surface with conductive windings thereon, where the top surface is provided with the winding pattern corresponding to the bottom winding on the PCB-(n-1) and the bottom surface is provided with a (n) winding pattern; and a lowermost first PCB where the top surface is provided with the winding pattern corresponding to the bottom winding on the PCB-n, and which is the same or at least similar to the uppermost first PCB but positioned with the winding facing upwards; where n is an integer number higher than 3; and means for holding the plurality of PCBs tightly against each other in the stacked configuration, and the frame encompasses the stack of PCBs.

In a second aspect there is provided a method of manufacturing a planar winding assembly for high-power applications, said method comprising the steps of:
building a stack of a plurality of printed circuit boards (PCBs), each comprising at least one conductive winding on the PCB, by
providing an uppermost first PCB comprising an electrically insulating layer having a top surface and a bottom surface, where the bottom surface is provided with a conductive winding having a first winding pattern; and
providing a second PCB comprising an electrically insulating layer having a top surface and a bottom surface with conductive windings thereon, where the top surface is provided with the first winding pattern and the bottom surface is provided with a second winding pattern mirroring the first winding pattern, and that said second PCB abuts the bottom side of the first PCB; and
providing a lowermost PCB, which is similar to the first PCB but positioned with the winding facing upwards;
whereby the plurality of PCBs are tightly held against each other in the stacked configuration, and then
encompassing the stack of PCBs comprising a first PCB and at least one second PCBs by the frame.

Hereby, a scalable modular solution is provided which is simple and inexpensive in manufacturing. The solution provided by the invention is highly scalable and modular and easy in manufacturing and assembling the planar magnetics with multiple series-connected windings.

When using the term “printed circuit board” or PCB in the present disclosure, there is meant any kind of board having an electrically insulating layer with a pattern of conductive material on one or both sides of said insulating layer. Thus, the term also covers the use of “direct bond copper”, where a copper foil is bonded directly to electrically insulating substrates.

In most preferred embodiments, the stack further comprises at least one third PCB comprising an electrically insulating layer having a top surface and a bottom surface with conductive windings thereon, where the top surface is provided with the second winding pattern and the bottom surface is provided with the first winding pattern. Accordingly, the stack preferably comprises an uppermost first PCB and a series of alternating second PCBs and third PCBs, so that the uppermost first PCB on its bottom side is abutted by the upper side of the second PCB, which on its bottom side is abutted by the upper side of the third PCB, which then may be abutted on its bottom side by a further second PCB, etc., and preferably the third PCB is the same or similar to the second PCB but positioned with upper and the lower sides reversed in position.

These advantages are achieved as the stacking of alternating second PCBs and third PCBs is repeated at least once, preferably a plurality of times. Thus, the stack comprises an uppermost first PCB and a series of alternating second PCBs and third PCBs, so that the uppermost first PCB on its bottom side is abutted by the upper side of the second PCB, which on its bottom side is abutted by the upper side of the third PCB, which then may be abutted on its bottom side by a further second PCB, etc. Hereby, a winding is provided between each of the PCBs and series-connected windings are achieved simply by providing three different PCB designs, where the first PCB is the top layer and in principle infinitely stackable altering second and third PCBs underneath the first PCB in the stack. Thus, a simple solution which is inexpensive to manufacture is provided.

Advantageously, the electrically insulating layer could be a ceramic layer. In particular, the PCBs may be of the Direct Bond Copper (DBC) type. This allows for that the planar winding assembly forming such a planar magnetics can be manufactured where no soldering is necessary. Furthermore, by the invention it is advantageous that all of the components of the planar winding assembly, in particular the PCBs in the winding assembly, are recyclable. In an alternative embodiment, the electrically insulating layer could be made of a ceramic, fibre glass, or epoxy resin.

Advantageously, the conductive windings are copper windings. Hereby, the thermal as well as the electric conductivity is increased.

Preferably, the PCBs are two-layered PCBs with direct bonded copper (DBC) windings on each side.

Advantageously, the conductive windings of the first, second and third PCBs are coil windings each having a first end and a second end, wherein the first end is the innermost end and the second end is the outermost end. Moreover, each of the first PCB, the second PCB and the third PCB may advantageously be provided with a central window around which the windings are provided.

To ensure the series of windings in the stack, the first ends of the top and bottom windings on the second PCB are connected through the ceramic layer of the second PCB. Furthermore, the second ends of the top and bottom windings on the third PCB are connected through the electrically insulating layer of the third PCB, so that the winding on the upper side of the second PCB is continued on the lower side of the third PCB.

In the preferred embodiments of the present disclosure, the frame comprises a set of core members made of a magnetic material. In particular, the set of core members preferably comprises an upper core member and a lower core member each having a central leg extending through the PCB windows and two side legs. In a particular embodiment, the core members are E-shaped.

In an embodiment, the stack of PCBs is encompassed by the core members that are assembled around the PCBs where the central legs of each core member about each other, and the side legs abut each other on each side of the PCBs. In particular, an adhesive tape is wound around the core members for firmly holding the core members together. Hereby, a simple and efficient enclosure of the stack is provided which allows for an easy assembly of the stack and the frame components.

In the preferred embodiment, the central legs of the core members are provided with a rectangular cross-sectional shape snugly fitting into the correspondingly shaped central windows of the PCBs. Hereby an accurate stacking is ensured so that the windings on the PCBs are ensured to align each other between the PCBs in the stack.

Preferably, the stack is clamped together by an external force to apply the pressure. In particular, it is found advantageous and simple that adhesive tape and/or metal tape is wound around the stack of PCBs for firmly holding the stack together.

The different PCBs in the stack can also be soldered or sintered along the abutting windings, and therefore the PCBs layers can be stacked without using an external force.

The planar winding assembly according to the invention may be an inductor or a transformer for medium-voltage and high-voltage, high power and high current applications. By the invention it is also realised that the planar winding assembly can be used without magnetic cores, and therefore it may also benefit busbar and power modules design and manufacturing.

In a particular embodiment of the assembly and the method of this disclosure, a fourth PCB is provided between a second PCB and a neighbouring third PCB in the stack to divide the stack into two coil windings connected in parallel, since said fourth PCB comprising an electrically insulating layer having a top surface and a bottom surface with conductive windings thereon, where the top surface is provided with the second winding pattern and the bottom surface is provided with a second winding pattern, and where both the first ends and the second ends of the top and bottom windings on the fourth PCB are connected to each other, respectively, through the electrically insulating layer of the fourth PCB.

By providing such fourth type of PCB in the stack, the direction of the windings formed by the stack can be reversed, and thereby instead of the stack forming one series of windings, the effect of the fourth PCB is that the windings can be divided into two parallel windings (or more if more fourth PCBs are inserted).

Regarding the fourth PCB, it is realised that no insulating layer is needed so in an alternative embodiment there is provided a metallic block between a second PCB and a neighbouring third PCB in the stack to divide the stack into two coil windings connected in parallel, since said metallic block is formed as conductive winding that correspond to the second winding pattern. The metallic block may be made of copper, silver, steel or any other suitable conductive metal to insert between two PCBs for enhancing the current capabilities.

As it is apparent from this alternative, the structure obtained by the fourth PCB is not limited to using a PCB, since no insulation substrate is needed. Therefore a pure electrically conductive block is enough to act as the parallel layers for increasing current ratings.

### DETAILED DESCRIPTION

In the following, the invention is described in more detail with reference to the embodiments shown in the accompanying drawings, in which:

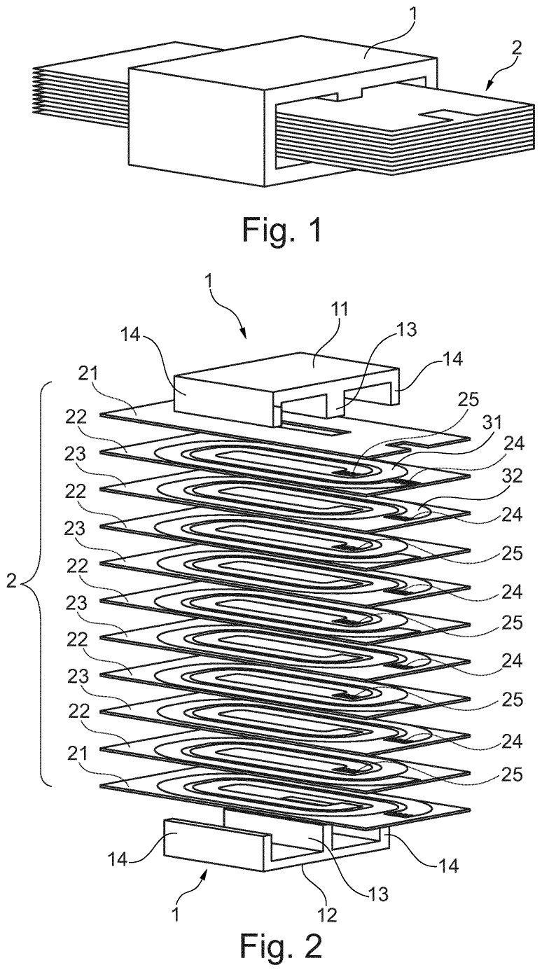

FIG. 1 is a schematic view of an embodiment of a planar winding assembly according to the invention;

FIG. 2 is an exploded view of the assembly in FIG. 1;

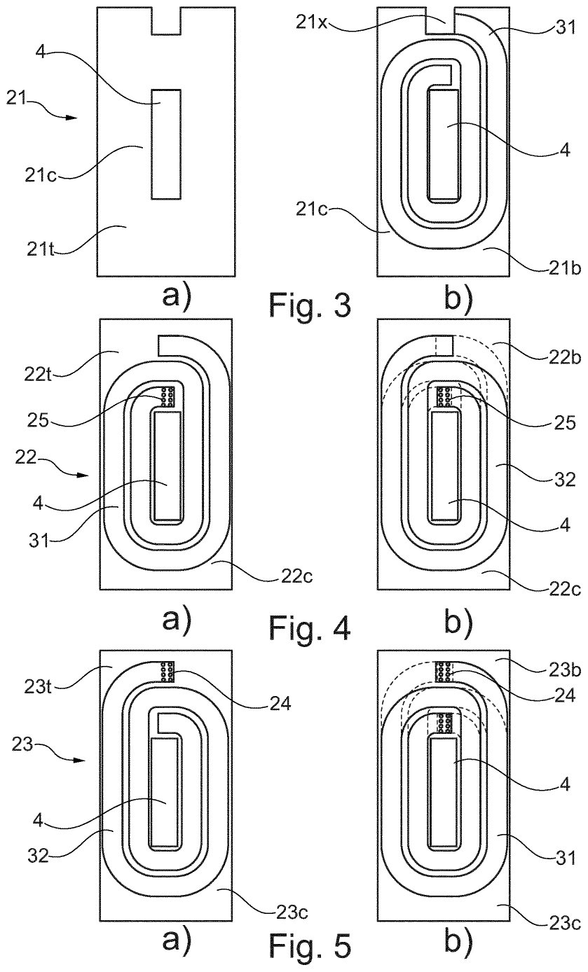

FIG. 3 a) and b) are top and bottom views—respectively—of a first PCB in an assembly according to the invention;

FIG. 4 a) and b) are top and bottom views—respectively—of a second PCB in an assembly according to the invention;

FIG. 5 a) and b) are top and bottom views—respectively—of a third PCB in an assembly according to the invention;

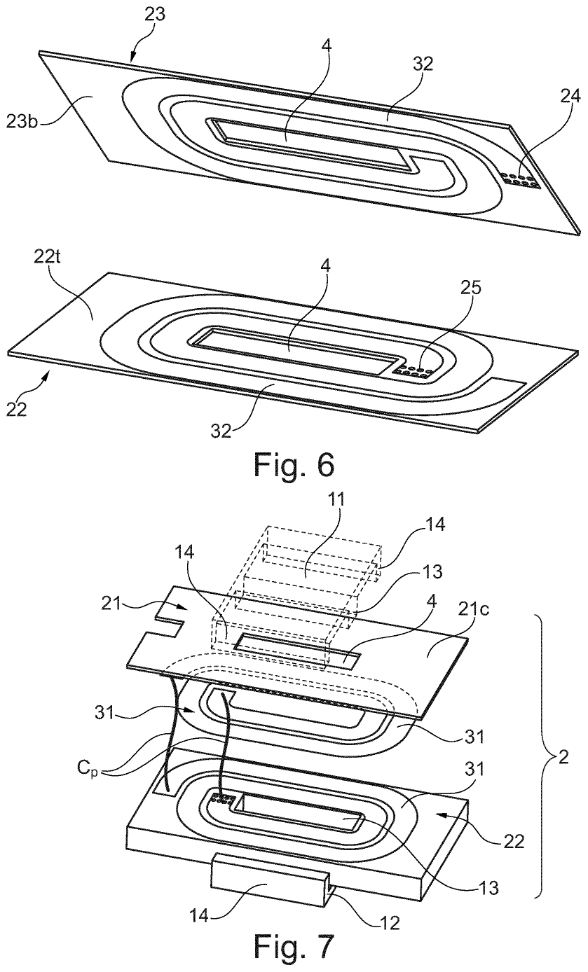

FIG. 6 is a detailed view of the assembly of the second and third PCBs in the stack;

FIG. 7 is a schematic, semi-exploded view of the assembly method of the first and second PCBs with the first PCB in exploded view and how the windings connect;

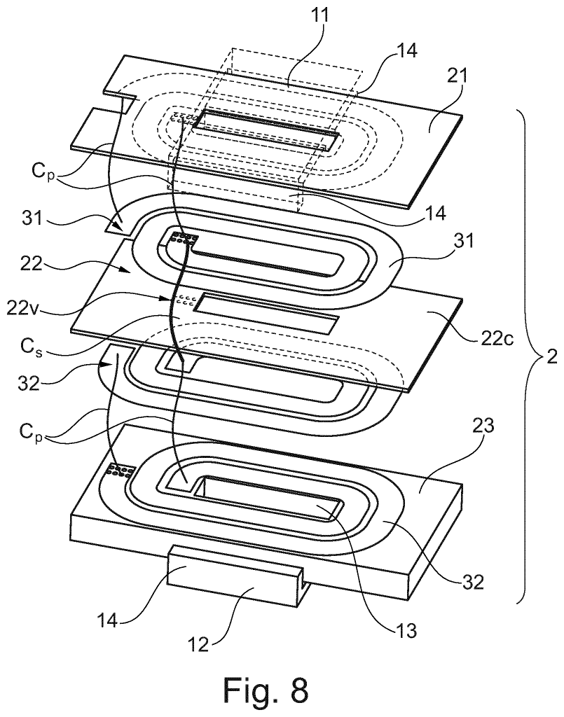

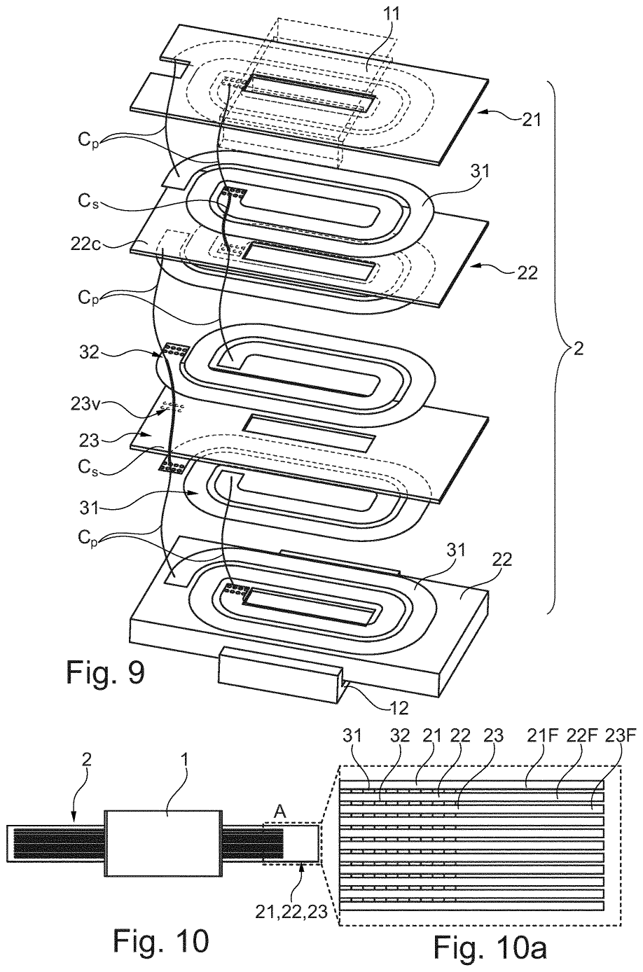

FIG. 8 is a schematic, semi-exploded view of the assembly method of the first, second and third PCBs with the second PCB in exploded view and how the windings connect;

FIG. 9 is a schematic, semi-exploded view of the assembly method of the first, second and third PCBs with the third PCB in exploded view and how the windings connect;

FIG. 10 is a schematic side view of an assembled planar magnetic according to an embodiment of the invention and with an enlarged detailed view in FIG. 10a;

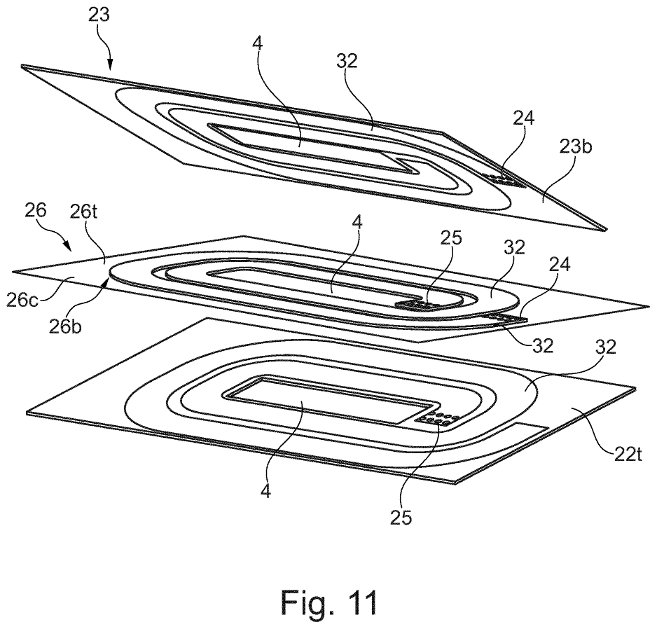

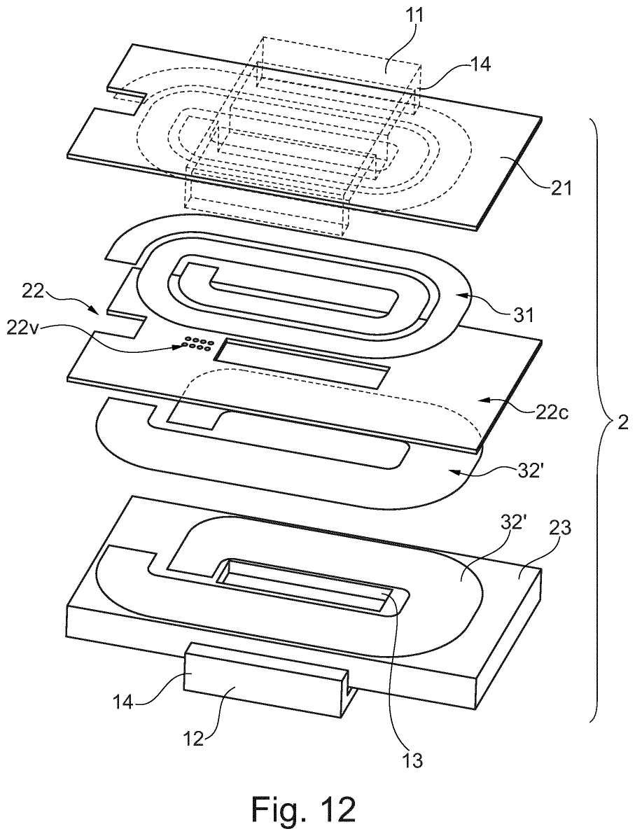

FIG. 11 is a detailed view detailed view of an embodiment of the assembly where a fourth PCB is inserted between the second and third PCBs in the stack;

FIG. 12 is a schematic, semi-exploded view of the assembly method of the upper and lower first PCBs and a second PCB with non-mirror-symmetrical windings; and

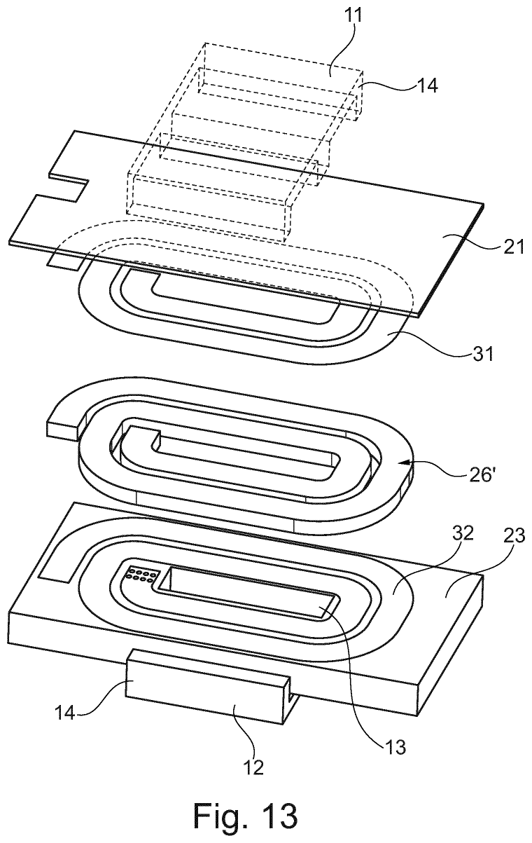

FIG. 13 is a schematic, semi-exploded view of the assembly method of the upper and lower first PCBs and a metal winding instead of a fourth PCB.

With reference to the figures, such as FIGS. 1 and 2, a planar winding assembly for high-power applications according to an embodiment of the invention is shown. The assembly comprises a frame 1 accommodating a stack 2 of a plurality of printed circuit boards (PCBs) 21, 22, 23. The PCBs comprise conductive windings 31, 32 on one or both sides of the PCBs as three different types of PCBs are provided. These types are shown in detail in the FIGS. 4 to 9. The PCBs 21, 22, 23 are tightly held together against each other in the stacked configuration by the frame 1 for forming a coil winding through the planar magnetic winding assembly (see also FIGS. 7 to 9).

In the stack 2, an uppermost first PCB 21 is provided. As shown in FIGS. 3a and 3b, this first PCB 21 comprises a ceramic layer 21c having a top surface 21t and a bottom surface 21b, where the bottom surface 21b is provided with a conductive winding 31 having a first winding pattern. Centrally, a rectangular central window 4 is provided in the ceramic layer 21c. This central window is formed to tightly fit around the central legs 13 of the upper and lower frame portions 11, 12 and the winding 31 is formed around this central window 4. Preferably, also a cut-away 21x is provided in the first PCB 21 so that an external connection point is established to the end of the coil winding in the finished planar winding assembly.

In the stack 2, below the first PCB 21, a second PCB 22 is provided. This second PCB 22 also comprises a ceramic layer 22c having a top surface 22t and a bottom surface 22b with conductive windings 31, 32 thereon. The top surface 22t is provided with the first winding pattern 31 and the bottom surface 22b is provided with a second winding pattern 32 mirroring the first winding pattern 31. Centrally, a rectangular central window 4 is provided in the ceramic layer 22c. This central window 4 is formed to tightly fit around the central legs 13 of the upper and lower frame portions 11, 12 and the windings 31, 32 are formed around this central window 4. The windings 31, 32 both have a first end 25 and a second end 24, where the first end 25 is the innermost end and the second end 24 is the outermost end. The innermost first ends 25 of the top and bottom windings 31, 32 on the second PCB 22 are connected in series C_{S} through the ceramic layer 22c of the second PCB 22 by a via connection 22v (see FIG. 8).

Below the second PCB 22, there is provided a third PCB 23. The third PCB 23 comprises a ceramic layer 23c having a top surface 23t and a bottom surface 23b with conductive windings 31, 32 thereon. The top surface 23t is provided with the second winding pattern 32 and the bottom surface 23b is provided with the first winding pattern 31 mirroring the second winding pattern 32. Centrally, a rectangular central window 4 is provided in the ceramic layer 23c. This central window 4 is formed to tightly fit around the central legs 13 of the upper and lower frame portions 11, 12 and the windings 31, 32 are formed around this central window 4. The windings 31, 32 both have a first end 25 and a second end 24, where the first end 25 is the innermost end and the second end 24 is the outermost end. The outermost second ends 24 of the top and bottom windings 31, 32 on the third PCB 23 are connected in series C_{S} through the ceramic layer 23c of the third PCB 23 by a via connection 23v (see FIG. 9).

In the assembly the stack comprises a plurality of PCBs 21, 22, 23 as shown in for instance FIG. 2 and in FIGS. 7 to 9. One uppermost first PCB 21 and a series of alternating second PCBs 22 and third PCBs 23 and finally a lowermost PCB 21, which is the same type as the uppermost first PCB 21 but flipped around. Hereby, the copper windings 31, 32 on the PCBs together form a coil winding through the planar assembly. This is achieved since the uppermost first PCB 21 on its bottom side 21b is abutted by the upper side 22t of the second PCB 22 connecting the two windings 31 in parallel C_{P}, which in turn on its bottom side 22b is abutted by the upper side 23t of the third PCB 23, which then further is abutted on its bottom side 23b by a further second PCB 22, etc. Thus, the abutment of the aligned windings 31 or 32 of two neighbouring PCBs 21, 22, 23 means that the windings can share the same current and therefore creates a parallel connection Cₚ. In FIG. 6 there is shown how the two PCBs, the second and third PCBs 22, 23 have aligned windings 32 on the bottom side 23b of the third PCB 23 (the upper one in the FIG. 6) and the top surface 22t on the second PCB 22 (the lower PCB in the FIG. 6). The stack 2 is insulated at the top and bottom by the first PCBs 21 finishing the stack 2 and ensures that all the windings are in internal layers of the whole structure after assembly and thus no winding is exposed to the outside.

In the preferred embodiments of the planar assembly disclosed and shown in the figures, on the PCBs 21, 22, 23 the conductive windings are copper windings. The PCBs 21, 22, 23 are two-layered PCBs with direct bonded copper (DBC) windings 31, 32 on each side.

As shown in FIG. 2 and also in FIGS. 7-9, the frame 1 comprises a set of core members 11, 12 made of a magnetic material. The set of core members comprises an upper core member 11 and a lower core member 12 each having a central leg 13 extending through the central windows 4 of the PCBs 21, 22, 23 and two side legs 14. Thus, the core members 11, 12 are E-shaped. The stack 2 of PCBs is encompassed by the frame core members 11, 12, which are assembled around the PCB stack 2 where the central legs 13 of each core member 11, 12 abut each other and the side legs 14 abut each other on each side of the PCB stack 2 to form the planar winding assembly as shown in FIG. 1.

The central legs 13 of the core members 11, 12 are provided with a rectangular cross-sectional shape snugly fitting into the correspondingly shaped central windows 4 of the PCBs 21, 22, 23.

Although not shown in the figures, it is found advantageous in some embodiments that an adhesive tape is wound around the core members 11, 12 for firmly holding the core members together and thereby also holding the stack 2 of PCBs. The stack of PCBs is advantageously held firmly together by adhesive tape to apply pressure so that the windings are pressed together and firmly electrically connected without using any soldering, but simply by utilising the precise alignment of the PCBs 21, 22, 23 in the stack 2 due to the shaping of the central windows 4 and the central legs 13 of the frame core members 11, 12.

The planar winding assembly according to the invention may be an inductor or a transformer for medium-voltage and high-voltage, high power and/or high current applications.

In FIG. 10 there is shown an embodiment of the planar winding assembly where the PCBs are provided with heat fins 21F, 22F and 23F at one side of the stack 2 which extends from the frame 1. The relevant side section of the assembly in FIG. 10 marked “A” is shown in an enlarged view in FIG. 10a. As can be seen in FIG. 10a, the heat fins 21F, 22F, 23F are provided as extensions of the ceramic layers of the first, second and third PCBs 21, 22, 23. When stacked, the ceramic layers of the PCBs 21, 22, 23 will naturally be separated by a small distance due to the copper windings 31, 32 on each side of the PCBs.

With reference to FIG. 11, there is disclosed a special embodiment of the invention, where a fourth PCB 26 is provided between a second PCB 22 and a neighbouring third PCB 23 in the stack 2 to divide the stack into two coil windings connected in parallel, since said fourth PCB 26 comprises a ceramic layer 26c having a top surface 26t and a bottom surface 26b with conductive windings 32 thereon. Both the top surface 26t and the bottom surface 26b are provided with a second winding pattern 32, and both the first ends 25 and the second ends 24 of the top and bottom windings 32 on the fourth PCB 26 are connected to each other, respectively, through the ceramic layer 26c of the fourth PCB 26. Hereby, the coil winding in the assembly is divided into two parallelly connected windings.

A variant of the embodiment shown in FIG. 11 is shown in FIG. 13, where the paralleling windings is achieved without a fourth PCB but utilising that there is the same copper trace/shape of the windings 31, 32 on the abutting sides of the neighbouring PCBs 21, 23, the insulation substrate of the fourth PCB is not necessary. Accordingly, in the embodiment shown in FIG. 13, a metal block 26′, for instance made of copper, with the special shape corresponding to the windings 31, 32 is enough, even without the insulation substrate as using PCBs.

In FIG. 12, there is shown an embodiment where the middle PCBs, such as the second PCB 22, has non-mirror-symmetrical structures on its upper and lower windings 31, 32′. As this embodiment shows, connection between different PCBs is possible and this may be advantageous in some implementations of the invention.

In general, when directional terms like “upper” and “lower” or similar directional references are used in the present disclosure, these terms are meant to be understood as relative terms e.g. where the term “upper” refers to a direction essentially opposite to the “lower”, but it is realised that the planar assembly when in use can be poisoned with any orientation.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A planar winding assembly for power applications, said assembly comprising a frame accommodating a stack of a plurality of printed circuit boards (PCBs), each comprising at least one conductive winding on the PCB, wherein the stack comprises
an uppermost first PCB comprising an electrically insulating layer having a top surface and a bottom surface, where the bottom surface is provided with a conductive winding having a first winding pattern;
at least one second PCB comprising an electrically insulating layer having a top surface and a bottom surface with conductive windings thereon, where the top surface is provided with the first winding pattern and the bottom surface is provided with a second winding pattern corresponding to the first winding pattern;
a lowermost first PCB, which is substantially the same as the uppermost first PCB but positioned with the winding facing upwards;
means for holding the plurality of PCBs tightly against each other in the stacked configuration, and
the frame encompasses the stack of PCBs.

2. (canceled)

3. An assembly according to claim 1, wherein the stack further comprises at least one third PCB comprising an electrically insulating layer having a top surface and a bottom surface with conductive windings thereon, where the top surface is provided with the second winding pattern and the bottom surface is provided with the first winding pattern.

4. An assembly according to claim 3, wherein the stack comprises an uppermost first PCB and a series of alternating second PCBs and third PCBs, so that the uppermost first PCB on its bottom side is abutted by the upper side of the second PCB, which on its bottom side is abutted by the upper side of the third PCB, which then may be abutted on its bottom side by a further second PCB, etc., and the third PCB is substantially the same as the second PCB but positioned with upper and the lower sides reversed in position.

5. An assembly according to claim 1, wherein the second winding pattern is corresponding to the first winding pattern by mirroring the first winding pattern or by matching with a non-mirroring pattern.

6. An assembly according to claim 1, wherein the electrically insulating layer is a ceramic layer or a layer made of fibre glass and/or epoxy resin, and wherein the conductive windings are copper windings.

7. (canceled)

8. An assembly according to claim 1, wherein the PCBs are two-layered PCBs with direct bonded copper (DBC) windings on each side.

9. An assembly according to claim 1, wherein the conductive windings of the first, second and third PCBs are coil windings each having a first end and a second end, wherein the first end is the innermost end and the second end is the outermost end, wherein the first ends of the top and bottom windings on the second PCB are connected through the electrically insulating layer of the second PCB.

10. (canceled)

11. An assembly according to claim 9, wherein the second ends of the top and bottom windings on the third PCB are connected through the electrically insulating layer of the third PCB.

12. An assembly according to claim claims, wherein the frame comprises a set of core members made of a magnetic material.

13. An assembly according to claim 1, wherein each PCB is provided with a central window around which the windings are provided, wherein the set of core members comprises an upper core member and a lower core member each having a central leg extending through the PCB windows and two side legs.

14. (canceled)

15. (canceled)

16. An assembly according to claim 13, wherein the stack of PCBs is encompassed by the core members that are assembled around the PCBs where the central legs of each core member abut each other and the side legs abut each other on each side of the PCBs.

17. An assembly according to claim 16, wherein an adhesive tape is wound around the core members for firmly holding the core members together.

18. (canceled)

19. An assembly according to claim 1, wherein the stack is clamped together by an external force to apply the pressure.

20. An assembly according to claim 1, wherein adhesive tape is wound around the stack of PCBs for firmly holding the stack together.

21. (canceled)

22. (canceled)

23. An assembly according to claim 1, wherein a fourth PCB is provided between a second PCB and a neighbouring third PCB in the stack to divide the stack into two coil windings connected in parallel, since said fourth PCB comprising an electrically insulating layer having a top surface and a bottom surface with conductive windings thereon, where the top surface is provided with the second winding pattern and the bottom surface is provided with a second winding pattern, and where both the first ends and the second ends of the top and bottom windings on the fourth PCB are connected to each other, respectively, through the electrically insulating layer of the fourth PCB.

24. An assembly according to claim 1, wherein a metallic block is provided between a second PCB and a neighbouring third PCB in the stack to divide the stack into two coil windings connected in parallel, since said metallic block is formed as a conductive winding that corresponds to the winding patterns of the second PCB and the neighbouring third PCB.

25. A method of manufacturing a planar winding assembly for power applications, said method comprising the steps of:
building a stack of a plurality of printed circuit boards (PCBs), each comprising at least one conductive winding on the PCB, by
providing an uppermost first PCB comprising an electrically insulating layer having a top surface and a bottom surface, where the bottom surface is provided with a conductive winding having a first winding pattern; and
providing a second PCB comprising an electrically insulating layer having a top surface and a bottom surface with conductive windings thereon, where the top surface is provided with the first winding pattern and the bottom surface is provided with a second winding pattern corresponding to the first winding pattern, and that said second PCB abuts the bottom side of the first PCB; and
providing a lowermost first PCB, which is the same or at least similar to the first PCB but positioned with the winding facing upwards;
whereby the plurality of PCBs are tightly held against each other in the stacked configuration, and then
encompassing the stack of PCBs comprising a first PCB and at least one second PCBs by the frame.

26. A planar winding assembly for power applications, said assembly comprising a frame accommodating a stack of a plurality number (N) of printed circuit boards (PCBs), each comprising at least one conductive winding on the PCB, wherein the stack comprises
an uppermost first PCB comprising an electrically insulating layer having a top surface and a bottom surface, where the bottom surface is provided with a conductive winding having a first winding pattern;
a PCB-2 comprising an electrically insulating layer having a top surface and a bottom surface with conductive windings thereon, where the top surface is provided with the first winding pattern and the bottom surface is provided with a second winding pattern;
a PCB-3 comprising an electrically insulating layer having a top surface and a bottom surface with conductive windings thereon, where the top surface is provided with the second winding pattern and the bottom surface is provided with a third winding pattern;
a PCB-(n-1) comprising an electrically insulating layer having a top surface and a bottom surface with conductive windings thereon, where the top surface is provided with the winding pattern corresponding to the bottom winding on the PCB-(n-2) and the bottom surface is provided with an (n-1) winding pattern;
a PCB-n comprising an electrically insulating layer having a top surface and a bottom surface with conductive windings thereon, where the top surface is provided with the winding pattern corresponding to the bottom winding on the PCB-(n-1) and the bottom surface is provided with an “n” winding pattern; and
a lowermost first PCB where the top surface is provided with the winding pattern corresponding to the bottom winding on the PCB-n, and which is the same or at least similar to the uppermost first PCB but positioned with the winding facing upwards;
where n is an integer number higher than 3; and
means for holding the plurality of PCBs tightly against each other in the stacked configuration, and
the frame encompasses the stack of PCBs.

27.-42. (canceled)
